(19) United States
(12) Patent Application Publication
(10) Pub. No.: US 2007/0050783 A1
(43) Pub. Date: Mar. 1, 2007

(54) Disk unit comprising tray and electronic apparatus comprising the same

(75) Inventor: Takeshi Makino, Echizen-city (JP)

Correspondence Address: JORDAN AND HAMBURG LLP, 122 EAST 42ND STREET, SUITE 4000, NEW YORK, NY, 10168, US

(73) Assignee: ORION ELECTRIC Co., Ltd., Echizen-city (JP)

(21) Appl. No.: 11/508,621

(22) Filed: Aug. 23, 2006

(30) Foreign Application Priority Data
Aug. 30, 2005 (JP) 2005-249826

(51) Int. Cl. G11B 17/04

(52) U.S. Cl. 720/601

(57) ABSTRACT

According to the present invention, an extending portion is integrally formed with a front end portion of a tray, and an upper edge frame is integrally formed with a main body frame above a tray opening thereof. When the tray is loaded in a unit casing, the extending portion and the upper edge frame overlap each other in a front-to-rear direction to form a double structure. The double structure provides both a function of closing the tray opening with substantially no gap and preventing broken disk pieces from being thrown out and a dustproof function. By providing such a simple and inexpensive structure which does not hinder the reduction of thickness, broken disk pieces are reliably prevented from being thrown out, and the dustproof function is provided when the tray is housed.

### CROSS REFERENCE TO RELATED APPLICATION

The disclosure of Japanese Patent Applications enumerated below including specification, drawings and claims is incorporated herein by reference in its entirety:

No. 2005-249826 filed Aug. 30, 2005.

### BACKGROUND OF THE INVENTION

1. Field of the Invention

The present invention relates to a disk unit comprising a tray for conveying a disk which is a storage medium, and an electronic apparatus comprising the disk unit. More particularly, the present invention relates to a disk unit having a structure for preventing a disk broken in the disk unit from being thrown out of the disk unit and a dustproof structure for preventing dust from entering into the disk unit, and an electronic apparatus comprising the disk unit.

2. Description of the Related Art

Among disk units capable of reproducing a disk, such as a DVD, a CD or the like, or disk units capable of recording and reproducing such a disk, there is a built-in-type disk unit which comprises a tray for placing a disk and is housed in an apparatus casing.

Examples of electronic apparatus products of such a built-in type include: a DVD (digital versatile disk) reproduction apparatus (a DVD player); a DVD recording/reproduction apparatus (a DVD recorder); a video/audio apparatus which is a combination of the DVD reproduction or recording/reproduction apparatus and a VCR (video cassette recorder), a cassette tape recorder, an HDD (hard disk drive) or the like; and the like.

The electronic apparatus having the built-in type disk unit has a tray door which is provided in front of a tray opening provided in a front surface of a unit casing through which a tray is loaded and unloaded, and is opened or closed in association with an conveyance action of the tray. The tray door is provided in a front panel serving as a front outer appearance of the electronic apparatus. As a result, when the tray is housed in the unit casing, the disk unit is not seen from the outside of the electronic apparatus.

When the disk unit writes and records information onto a disk or reads and reproduces information recorded on a disk, the tray which is initially housed in the unit casing of the disk unit needs to be unloaded from the electronic apparatus, and thereafter, the disk needs to be loaded from the outside of the electronic apparatus into the unit casing. Therefore, the user selects and presses one of operation buttons provided on the front panel which is used to unload the tray (open/close button), so that a tray drive mechanism provided in the unit casing of the disk unit acts in a direction in which the tray is unloaded from the electronic apparatus, and therefore, the tray door provided in the front panel is opened in association with the tray unloading action. The tray present in the unit casing is unloaded from the electronic apparatus via the tray opening provided in the front surface of the unit casing and an opening portion opened by the association action of the tray door provided in the front panel.

A disk is placed onto the tray unloaded from the electronic apparatus, and thereafter, the user lightly pushes a front end portion of the tray or presses the “open/close” operation button provided on the front panel, so that the tray drive mechanism acts in a direction in which the tray is loaded into the unit casing of the disk unit built in the electronic apparatus. Therefore, the tray is withdrawn and housed into the unit casing via the opening portion of the front panel where the tray door is open, and the tray opening provided in the front surface of the unit casing. Note that the tray door provided in the front panel closes the opening portion in association with the tray loading action.

The disk on the tray which has been loaded into the electronic apparatus is rotated while being held slightly above the tray by a turntable provided in the unit casing of the disk unit. In this state, information is written onto the disk or information recorded on the disk is read, using a well-known optical technique.

When recording or reproduction of the disk is ended, the tray on which the disk is being placed is unloaded from the electronic apparatus by the above-described tray unloading action. In this state, the disk can be removed or exchanged. Thereafter, the tray is loaded into the unit casing of the disk unit by the above-described tray loading action.

### SUMMARY OF THE INVENTION

The disk unit of this type has substantially a U shape such that, as illustrated in FIGS. 5 or 6, a front surface of a unit casing 101 providing an outer appearance of a disk unit 100 has a bottom surface and both side walls, and a tray opening 102 which is wider than it is long and is open upward. A tray 103 on which a disk is placed and conveyed and which can be loaded and unloaded through the tray opening 102, is assembled with the unit casing 101.

A rotational speed of the turntable provided in the disk unit is, for example, about 2000 rpm (revolutions/minute), which is sufficient for reproduction-dedicated DVD players. DVD recorders capable of recording and reproduction require a rotational speed of as high as about 9000 rpm. The rotational speed tends to be further increased with a recent increase in the speed of digital processing or the like.

When the disk on the turntable is rotated at such high speed, the rotating disk may be broken due to damage, though it is considerably rare. When the rotating disk is broken, broken pieces of the disk which are scattered from the tray opening 102 due to centrifugal force are thrown out of the disk unit 100, and in addition, are likely to be thrown of the electronic apparatus through a tray door (not shown) provided in the front panel, in the case of the structure of FIGS. 5 and 6.

Particularly, to reduce size and cost, the unit casing 101 of the disk unit 100 is formed of a synthetic resin. Also, an upper front portion of the unit casing 101 has the tray opening 102 which is open upward. Therefore, due to the structure, broken pieces of a disk are easily thrown out through the tray opening 102 without striking the tray 103 or the like.

Therefore, the following structure has been proposed (e.g., Japanese Patent Laid-Open Publication No. 2002-133852). In a disk unit of this type, a first protrusion bent to an arc is provided on a surface of the tray along an outer periphery of a disk, and a second protrusion protruding downward is provided on an inner surface of a top plate in a manner which allows it to overlie the first protrusion. Thereby, when the tray is withdrawn and housed into the unit casing, even if a rotating disk is broken, walls of the first and second protrusions can prevent broken pieces of the disk from being thrown out.

As described above, it is complicated and is not easy to provide the first protrusion on the tray for placing a disk, and provide the second protrusion on the top plate of the unit in alignment with the first protrusion, in terms of processing and assembly of parts, and also cost and miniaturization of the unit (considerably thin unit). In addition, when only the first and second protrusions are provided, it is difficult to prevent dust from entering into the unit casing through a gap in the tray opening. Therefore, it is necessary to additionally take measures so as to provide a dustproof function.

An object of the present invention is to provide a disk unit of this type and an electronic apparatus comprising the disk unit which have a simple and inexpensive structure which does not hinder the reduction of thickness, and reliably prevent broken pieces of a disk rotated by a turntable from being thrown out of the disk unit, and in addition, obtain a dustproof effect when a tray is housed.

To achieve the object, a disk unit with a tray according to a first aspect of the present invention, comprises, at least, a unit casing composed of a main body frame open upward and a plate covering the upper opening of the main body frame, and a tray for placing and conveying a disk. A cut of a front surface of the main body frame is provided as a tray opening through which the tray is loaded and unloaded, the cut being wider than it is long. The tray performs a disk unloading action of pushing the tray from the inside of the unit casing via the tray opening toward the front of the unit casing, and a disk loading action of withdrawing and housing the tray via the tray opening into the unit casing. An upper edge frame is provided upside of the tray opening on the front surface of the main body frame, the upper edge frame being wider than it is long, and a protrusion-like extending portion extending higher than an upper edge of the tray opening is provided at a front end portion of the tray, so that the upper edge frame and the extending portion close the tray opening when the tray is loaded.

Therefore, according to the disk unit of the first aspect of the present invention, when the tray for placing and conveying a disk is loaded in the unit casing, the extending portion provided at the front end of the tray and the upper edge frame provided on the front surface of the main body frame overlap each other in a front-to-rear direction at the tray opening provided in the main body frame (the extending portion is in front of the upper edge frame). In this state, the extending portion provided at the front end portion of the tray externally covers the main body frame to close the tray opening. Therefore, for example, when a disk rotated at a high speed of about 9000 rpm is broken, and broken pieces of the disk are scattered at considerably high speed, the double structure of the extending portion and the upper edge frame can reliably prevent the broken disk pieces from being thrown out.

In addition, the double structure of the extending portion and the upper edge frame eliminates a gap which otherwise conventionally occurs between the tray and the tray opening when the tray is housed in the unit casing, thereby making it possible to provide a dustproof effect with respect to the inside of the unit casing.

In addition, the simple structure in which the extending portion and the upper edge frame overlap each other in the front-to-rear direction allows simple and easy processing and assembly of parts. In addition, the extending portion and the upper edge frame overlapping each other in the front-to-rear direction do not have an influence on the height of the disk unit. Thus, with the simple and inexpensive structure which does not hinder the reduction of thickness, it is possible to reliably prevent broken pieces of a disk from being thrown out of the disk unit, and in addition, obtain a dustproof effect when the tray is housed.

Next, according to a second aspect of the present invention, in the disk unit with the tray of the first aspect of the present invention, the tray and the extending portion are integrally formed, and the main body frame and the upper edge frame are integrally formed.

Therefore, according to the disk unit of the second aspect of the present invention, the tray and the extending portion provided at the front end of the tray are integrally formed of, for example, a resin. Also, the main body frame and the upper edge frame provided on the front surface of the main body frame are integrally formed of, for example, a resin. Thereby, a disk unit having an effect similar to that of the first aspect can be provided using a more inexpensive and practical structure without increasing the number of parts.

Next, according to a third aspect of the present invention, an electronic apparatus comprises the disk unit with the tray of the first or second aspect of the present invention, in which a tray door which is opened or closed in association with a conveyance action of the tray is provided in front of the tray opening provided in the main body frame, and the tray door is provided in a front panel of an apparatus casing constituting an outer appearance.

Therefore, according to the electronic apparatus comprising the disk unit of the third aspect of the present invention, the disk unit of the first or second aspect of the present invention is provided in the apparatus casing including the front panel having the tray door which can be opened or closed in association with the conveyance action of the tray. Thereby, it is possible to obtain an effect similar to that of the first or second aspect of the present invention, and provide an electronic apparatus comprising a disk unit which is inexpensive and significantly improves safety and a dustproof function.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1A is a perspective view illustrating a state of a disk unit according to an embodiment of the present invention where a tray is unloaded.

FIG. 1B is a side view illustrating a state of the disk unit of the embodiment of the present invention when the tray is unloaded.

FIG. 2A is a perspective view illustrating a state of the disk unit of the embodiment of the present invention when the tray is loaded.

FIG. 2B is a side view illustrating a state of the disk unit of the embodiment of the present invention when the tray is loaded.

FIG. 3 is an enlarged cross-sectional side view illustrating a front surface of a main body frame of the disk unit of the embodiment of the present invention when the tray is housed.

FIG. 4A is a perspective view illustrating a state of an electronic apparatus comprising the disk unit of the embodiment of the present invention when the tray is unloaded.

FIG. 4B is a side view illustrating a state of an electronic apparatus comprising the disk unit of the embodiment of the present invention when the tray is loaded.

FIG. 5 is a side view illustrating a state of a conventional exemplary disk unit when a tray is unloaded.

FIG. 6 is an enlarged side view illustrating a front surface of a main body frame of the conventional exemplary disk unit when the tray is housed.

### DETAILED DESCRIPTION OF THE PREFERRED EMBODIMENT

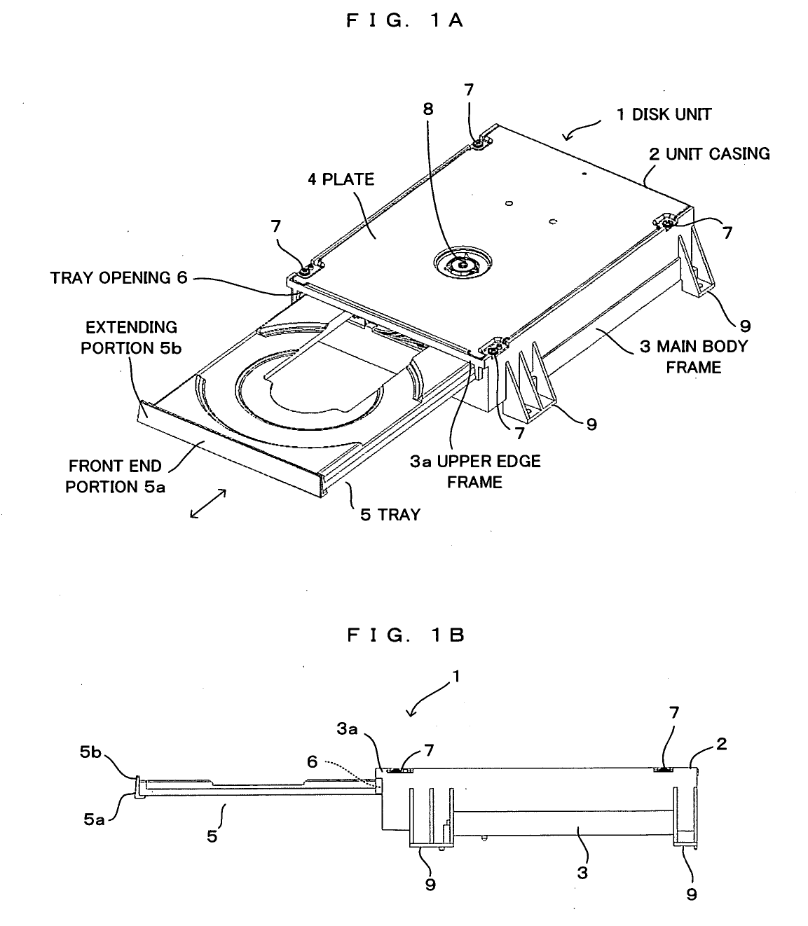

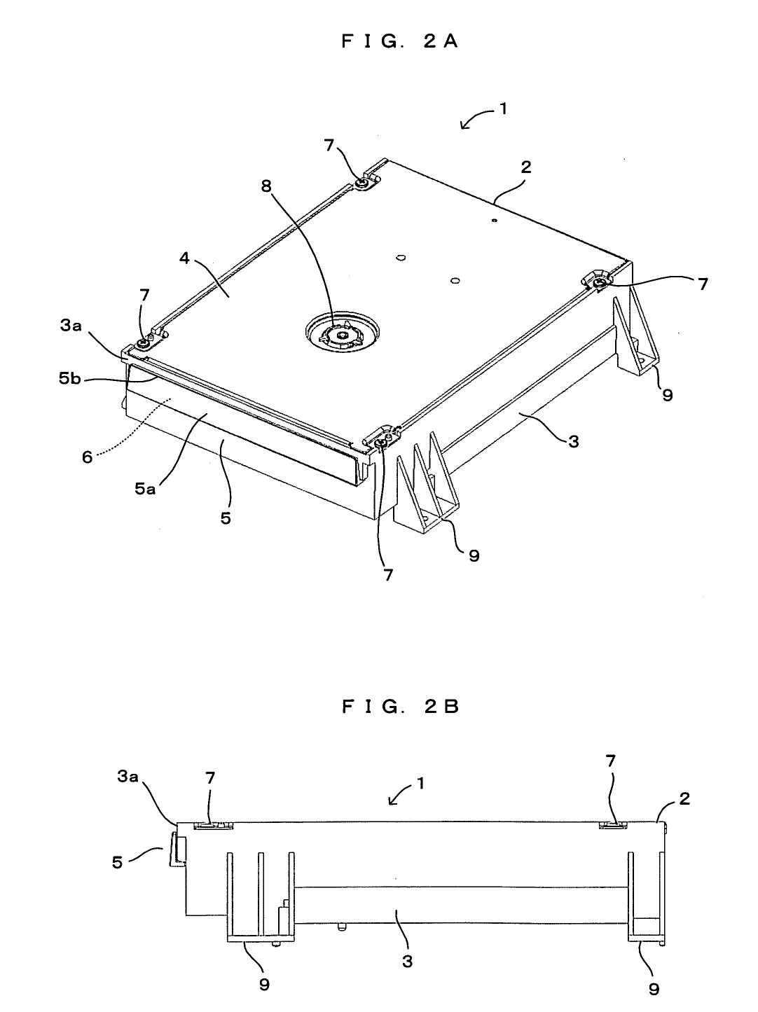

Hereinafter, in order to describe the present invention in greater detail, an embodiment thereof will be described with reference to FIGS. 1A to 4B.

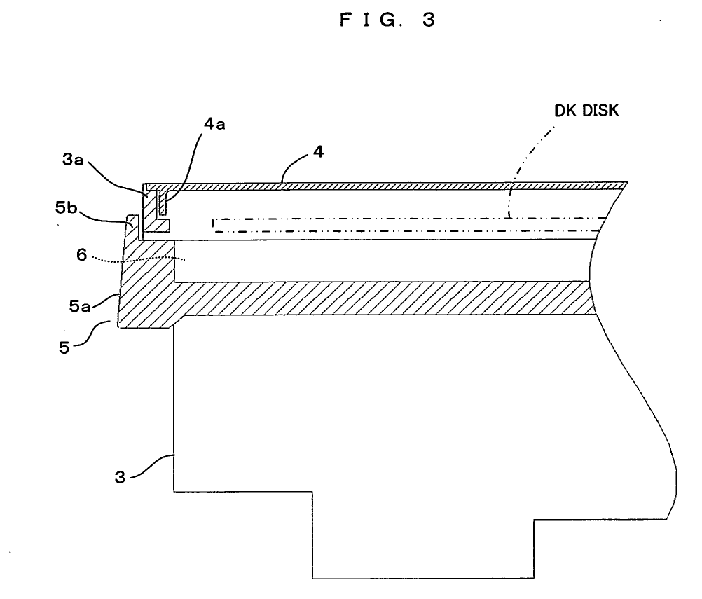

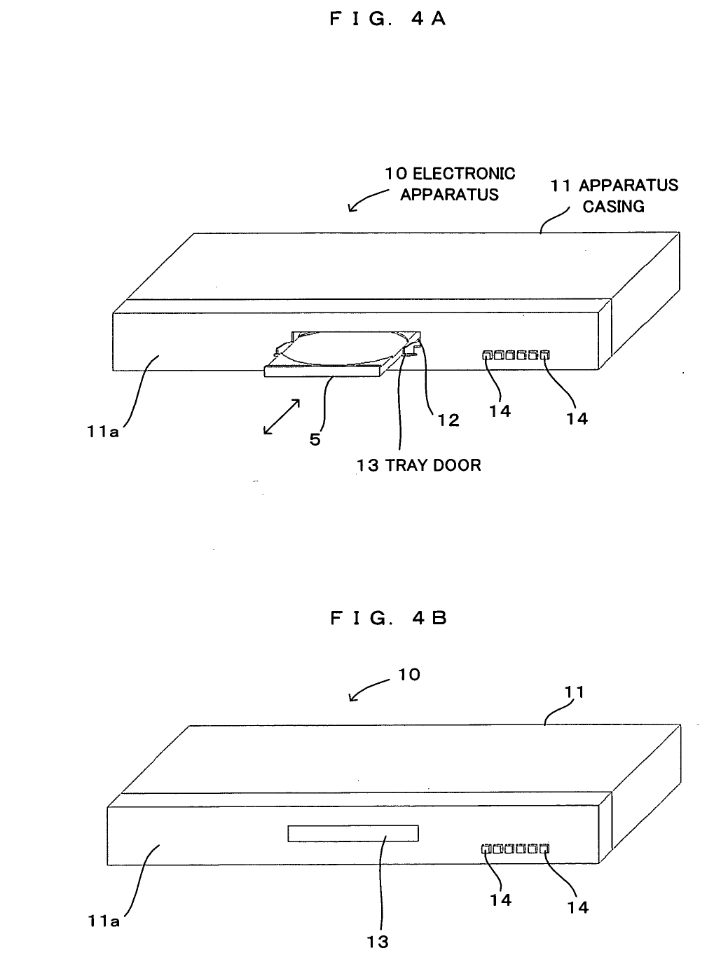

FIGS. 1A and 1B illustrate a state of a disk unit where a tray is unloaded. FIG. 1A is a perspective view illustrating the state of the disk unit when the tray is unloaded, and FIG. 1B is a side view illustrating the state of the disk unit when the tray is unloaded. FIGS. 2A and 2B illustrate a state of the disk unit when the tray is loaded (housed). FIG. 2A is a perspective view illustrating the state of the disk unit when the tray is loaded, and FIG. 2B is a side view illustrating the state of the disk unit when the tray is loaded. FIG. 3 is an enlarged cross-sectional side view illustrating a front surface of a main body frame when the tray is housed. FIGS. 4A and 4B illustrate an electronic apparatus having a built-in disk unit. FIG. 4A is a perspective view illustrating a state of the electronic apparatus when the tray is unloaded, and FIG. 4B is a perspective view illustrating a state of the electronic apparatus when the tray is loaded.

The disk unit 1 has a function of optically reproducing, or recording and reproducing, a disk, such as a DVD, a CD or the like. As illustrated in FIGS. 1A and 1B and FIGS. 2A and FIG. 2B, the disk unit 1 comprises a flat box-shaped unit casing 2. The unit casing 2 is composed of a main body frame 3 which is open upward and is formed of a synthetic resin, and a thin metal plate 4 which serves as a top plate for covering the upper opening of the main body frame 3. The main body frame 3 and the plate 4 constitute an outer appearance shape of the disk unit 1.

In the main body frame 3, similar to well-known disk units, the following parts are provided: a tray 5 on which a disk is placed and which is assembled with the main body frame 3 in a manner which allows it to linearly reciprocate in a front-to-rear direction by a tray drive mechanism when a disk is loaded and unloaded; a rack loading (not shown) which is slid in a direction perpendicular to a movement direction of the tray 5 in association with linear reciprocation of the tray 5; a chassis (not shown) which is inclined in the unit casing 2 in association with the sliding action of the rack loading; a turntable (not shown) which is attached to the chassis and is used to rotate a disk; a pickup unit (not shown) which is used to optically record or reproduce a disk which is mounted on the turntable and is rotated; a guiding mechanism (not shown) which allows the pickup unit to linearly reciprocate in a surface traverse direction of a disk on the turntable; and the like.

The main body frame 3 of this embodiment is formed of a molded synthetic resin in view of cost, weight, ease of processing and the like of the disk unit 1. Also, the tray 5 for conveying a disk is formed of a molded synthetic resin in view of a load of the tray 5 to the tray drive mechanism and the like as well as the reasons for the main body frame 3.

Also, a horizontal cut which is wider than it is long is provided at an upper end portion of a front surface of the main body frame 3. With this cut, a tray opening 6 is provided through which the tray 5 is loaded and unloaded.

The plate 4 is formed of a metal in view of an improvement in strength of the main body frame 3 and taking measures against, for example, unnecessary radiation to the disk unit 1. The plate 4 is supported by a step portion 3a (FIG. 3) provided inside an upper portion of the main body frame 3 and is inserted into the upper portion of the main body frame 3, and four corners of the plate 4 are fixed to the main body frame 3 with screws 7. In this case, as illustrated in FIG. 3, a front end portion of the plate 4 (excluding both ends thereof) are bent downward and are located on an inner surface (a rear surface) of an upper edge frame described below, to form a bent portion 4a which is a backing member for reinforcement.

A damper (disk clamper) 8 is attached to a position which is closer to the front of the plate 4 and faces the turntable. The damper 8 and the turntable sandwich and hold a disk when the turntable attached to the chassis is lifted by the inclining action of the chassis so that the disk placed on the tray 5 is held up. The damper 8 is freely rotated as with general disk clampers, and clamps a rotating disk on the turntable using a magnetic attraction force generated by a magnet provided in the damper 8 and a magnetic material of the turntable. Note that the damper 8 is attached to the plate 4, leaving a small gap (clearance) in a vertical direction therebetween so that a rotating disk can be allowed to slightly wobble due to a warp or the like.

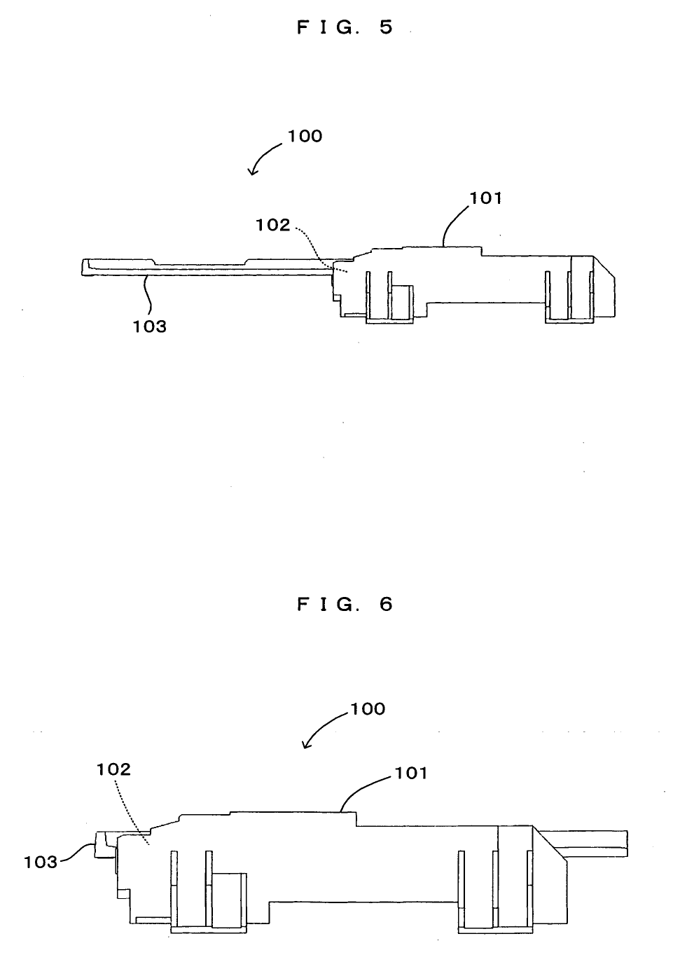

Next, the tray 5 is different from the conventional tray 103 of FIGS. 5 and 6 in that, as illustrated in FIG. 3, a protrusion-like extending portion 5b is integrally formed with a front end portion 5a of the tray 5, and the extending portion 5b uniformly extends from the whole front end portion 5a so that an upper edge of the extending portion 5b is higher than an upper edge of the tray opening 6.

An upper edge frame 3a for the tray opening 6 is provided and integrally formed with the main body frame 3. A lower edge portion of the upper edge frame 3a is bent toward the inside of the main body frame 3 (in a rear direction of FIG. 3), i.e., the upper edge frame 3a has substantially an L-shape cross-section.

When the tray 5 is withdrawn and housed in the unit casing 2 (loaded state), the extending portion 5b provided at the front end portion 5a of the tray 5 externally covers and closes the tray opening 6. In this case, the extending portion 5b of the tray 5 is located in front of the upper edge frame 3a of the main body frame 3, overlapping each other in a front-to-rear direction at an upper edge portion of the tray opening 6. The double structure having the overlap in the front-to-rear direction provides both a function of preventing pieces of a disk broken during rotation from being thrown out through the tray opening 6 and a dustproof function with respect to the inside of the unit casing 2. In addition, in the case of the embodiment, the bent portion 4a of the metal plate 4 is provided on the rear surface of the upper edge frame 3a for the purpose of reinforcement, whereby the bent portion 4a further prevents broken pieces of a disk from being thrown out through the tray opening 6.

Thus, when the tray 5 is housed, the extending portion 5b of the tray 5 and the upper edge frame 3a of the main body frame 3 form the double structure having the overlap in the front-to-rear direction to reliably close the tray opening 6. Therefore, for example, when a disk which is clamped on the turntable which is rotated at a high speed of about 9000 rpm is broken due to damage or the like in the unit casing 2, and broken pieces of the disk are scattered at considerably high speed, the double structure in which the extending portion 5b and the upper edge frame 3a overlap each other can reliably prevent the broken disk pieces from being thrown out. In addition, in the case of the embodiment, the bent portion 4a formed of a metal provided on the rear surface of the upper edge frame 3a can further provide a sturdy protection structure against a strike force of the broken disk pieces, thereby more reliably providing the prevention effect.

In addition, when the tray 5 is housed, the double structure blocks dust from entering a gap between the tray 5 and the tray opening 6, thereby making it possible to provide a dustproof effect.

Next, an exemplary electronic apparatus comprising the disk unit 1 will be described. Attachment pieces 9 provided at four lower corners of the main body frame 3 are fixed with screws or the like at predetermined portions in an apparatus casing 11 as an outer casing of an electronic apparatus 10 illustrated in FIGS. 4A and 4B. Note that the electronic apparatus 10 is, for example, a DVD player, a DVD recorder, or a combination-type video/audio apparatus in which a DVD player or a DVD recorder is combined with a VCR, a cassette tape recorder, an HDD or the like.

On a front panel 11 a which serves as a front surface of the apparatus casing 11, an opening portion 12 through which the tray 5 is loaded and unloaded is provided at substantially a middle portion of the front panel 11a and at a position where the opening portion 12 overlaps the tray opening 6 provided in the main body frame 3 of the disk unit 1 fixed in the apparatus casing 11. A decorative tray door 13 is attached to the opening portion 12. The tray door 13 can be rotated so that, when the tray 5 is loaded and unloaded, an upper edge portion thereof falls forward from a vertical state (the tray door 13 is opened) or rises in the opposite direction (the tray door 13 is closed). Note that, during the normal time, the tray door 13 is closed by a biasing means (not shown) so that the disk unit 1 is not viewed from the outside of the electronic apparatus 10.

In addition, a plurality of operation buttons 14 required for the loading/unloading action of the tray 5, recording or reproduction of a disk housed in the disk unit 1, and the like are provided at a lower right portion of the front panel 11a.

When the user presses an “open/close” operation button for the tray 5 provided on the front panel 11a so as to reproduce or record a disk, the tray drive mechanism of the disk unit 1 built in the electronic apparatus 10 is operated so that the tray 5 starts moving toward the outside of the unit casing 2. The tray door 13 is opened in association with the action of the tray 5. The tray 5 pushed out of the unit casing 2 of the disk unit 1 is unloaded toward the front of the electronic apparatus 10 via the tray opening 6 and the opening portion 12 which is provided in the front panel 11a and through which the tray 5 is loaded and unloaded.

In this state, the user places a disk onto the tray 5, and thereafter, for example, presses the “open/close” operation button for the tray 5 again. Thereby, the tray 5 on which the disk is being placed is withdrawn and loaded into the disk unit 1 provided in the electronic apparatus 10. The tray door 13 is rotated in a direction which closes the opening portion 12 which is provided in the front panel 11a and through which the tray 5 is loaded and unloaded, in association with the withdrawal action of the tray 5.

The operation of the disk unit 1 of the example will be described in more detail. The rack loading (not shown) linked to the tray 5 is slid in a direction perpendicular to the moving direction of the tray 5 in association with the loading action of the tray 5. A front end portion of the chassis (not shown) attached to the main body frame 3 is inclined upward using a rear end portion thereof linked to the main body frame 3 as a pivot point in association with the sliding action of the rack loading, so that the chassis, which was in the inclined position when the tray 5 was unloaded, is moved into a horizontal position when the tray 5 is loaded.

The turntable, the pickup unit and the like are attached to the chassis. The disk placed on the tray 5 is held up slightly by the turntable due to the inclining action of the chassis. Also, the disk is sandwiched by the turntable and the damper 8 in a manner which allows the disk to freely rotate. In this case, the disk is in a position of an imaginary disk DK indicated with a dash-dot-dot line in FIG. 3, i.e., is held at a position having a height of the double structure of the extending portion 5b and the upper edge frame 3a.

Thereafter, the turntable is driven and rotated so that the disk is rotated at a high speed of, for example, 9000 rpm. Using laser light emitted from the pickup unit onto a recording surface of the disk, information is read (reproduced) from or written (recorded) onto the disk using a well-known optical technique.

When recording or reproduction of the disk is performed while the tray 5 is being housed, the extending portion 5b provided at the front end of the tray 5 and the upper edge frame 3a provided on the front surface of the main body frame 3 overlap each other in the front-to-rear direction as described above, so that the double structure having the overlap can reliably close the tray opening 6 with substantially no gap. Therefore, even if a disk rotating at high speed is broken in the disk unit 1, broken pieces thereof are not thrown out of the disk unit 1. Thus, according to this structure, there is substantially no risk that suddenly broken disk pieces are thrown out through the tray door 13 toward the front of the electronic apparatus 10, resulting in considerably high safety. Also, in the case of the embodiment, the bent portion 4a of the plate 4 is provided on the rear surface of the upper edge frame, so that it is possible to more reliably prevent from broken disk pieces from being thrown out of the disk unit 1, resulting in a further improvement in safety.

In addition, due to the double structure of the extending portion 5b and the upper edge frame 3a, there is substantially no gap in the tray opening 6 when the tray 5 is housed. Therefore, a dustproof effect with respect to the inside of the disk unit 1 can be achieved as well as the effect of preventing broken disk pieces from being thrown out. As a result, particularly, it is possible to reliably prevent dust or the like from adhering to a laser light emitting lens of the pickup unit, resulting in an improvement in life and reliability of the product.

The extending portion 5b, the upper edge frame 3a, and the bent portion 4a are integrally formed with the tray 5, the main body frame 3, and the plate 4, which are essential parts of the disk unit 1, respectively. Therefore, the number of parts is not increased, and assembly is as easy as the conventional art. In addition, the double structure does not have an influence on the height of the disk unit 1, and does not hinder the reduction of thickness of the disk unit 1.

Therefore, a simple and inexpensive structure which does not hinder the reduction of thickness can be used to provide a means which prevents broken disk pieces from being thrown out through the tray opening 6 and is also dustproof, thereby making it possible to reliably prevent broken disk pieces from being thrown out of the disk unit 1, and provide the dustproof effect to the disk unit 1 when the tray is housed. As a result, with the inexpensive structure, the safety, reliability and the like of the electronic apparatus 10 comprising the disk unit 1 can be improved.

In the case of the embodiment, the tray 5, the extending portion 5b, the main body frame 3 and the upper edge frame 3a are integrally formed using a molded synthetic resin, advantageously resulting in a practical and more inexpensive product.

The present invention is not limited to the above-described embodiment. Other changes can be made without departing the spirit and scope of the present invention. For example, the present invention is also applicable when the tray 5 and the main body frame 3 are formed of a metal or the like other than resins. Also, the top plate of the main body frame 3 may be formed of a resin or the like and may be integrally formed with or separated from the may body frame 3.

The bent portion 4a is not particularly provided, for example, when the double structure of the extending portion 5b and the upper edge frame 3a has a sufficient strength.

The disk unit 1 may have any outer appearance and internal structure, excluding the extending portion 5b provided to the tray 5 and the upper edge frame 3a provided to the main body frame 3, and may be housed in outer casings of any various apparatuses.

The apparatus casing 11and the tray door 13 of the electronic apparatus 10 may have any shape, structure, and the like.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A disk unit with a tray comprising at least:
(a) a unit casing including
(a-1) a main body frame open upward; and
(a-2) a plate covering said upper opening of said main body frame; and
(b) a tray for placing and conveying a disk, wherein
a cut of a front surface of said main body frame is provided as a tray opening through which said tray is loaded and unloaded, said cut being wider than it is long,
said tray performs a disk unloading action of pushing said tray from the inside of said unit casing via said tray opening toward the front of said unit casing, and a disk loading action of withdrawing and housing said tray via said tray opening into said unit casing, and
an upper edge frame is provided upside of said tray opening on said front surface of said main body frame, said upper edge frame being wider than it is long, and
a protrusion-like extending portion extending higher than an upper edge of said tray opening is provided at a front end portion of said tray, so that said upper edge frame and said extending portion close said tray opening when said tray is loaded.

2. The disk unit with said tray according to claim 1, wherein said tray and said extending portion are integrally formed, and
said main body frame and said upper edge frame are integrally formed.

3. An electronic apparatus comprising said disk unit with said tray according to claim 1,
wherein a tray door which is opened or closed in association with a conveyance action of said tray is provided in front of said tray opening provided in said main body frame, and
said tray door is provided in a front panel of an apparatus casing constituting an outer appearance.

4. An electronic apparatus comprising said disk unit with said tray according to claim 2,
wherein a tray door which is opened or closed in association with a conveyance action of said tray is provided in front of said tray opening provided in said main body frame, and
said tray door is provided in a front panel of an apparatus casing constituting an outer appearance.
